(19) United States
(12) Patent Application Publication
(10) Pub. No.: US 2010/0261376 A1
(43) Pub. Date: Oct. 14, 2010

(54) Electrical power apparatus with flat retractable cords and spools

(76) Inventors: Mina Hwang, Coral Springs, FL (US); Dan M. DeLaRosa, Coral Springs, FL (US)

Correspondence Address: Dan DeLaRosa, Suite 24C, 300 E 77th Street, New York, NY, 10075, US

(21) Appl. No.: 12/802,709

(22) Filed: Jun. 14, 2010

Related U.S. Application Data
(63) Continuation-in-part of application No. 12/378,536, filed on Feb. 17, 2009, now Pat. No. 7,758,376.
Application No. 12/378,536 is a division of application No. 11/805,349, filed on May 23, 2007, now Pat. No. 7,510,426.
(60) Provisional application No. 60/808,448, filed on May 26, 2006.

(51) Int. Cl. H01R 13/72

(52) U.S. Cl. 439/501

(57) ABSTRACT

A surge protector apparatus is provided, the apparatus comprises: a housing comprising a top portion, a bottom portion and side walls creating an external surface generally perpendicular to the top and bottom portions and an internal cavity; at least one surge protector and at least one spool situated within the internal cavity of the housing; and at least one extendable and retractable cord having opposing ends, at least one socket component is directly attached to one end of the cord, and the opposing end of the cord is attached to a portion of the spool, and the cord has at least one flat side surface, and the flat surface of the cord contacting a portion of the spool during a retracted position.

### RELATED APPLICATION:

This application is a continuation-in-part application of application U.S. application Ser. No. 12/378,536, entitled “Electrical Power Apparatus with Retractable Cords and Moveable Sockets” which was filed on Feb. 17, 2009, which has been granted a Notice of Allowance and which is a divisional of U.S. application Ser. No. 11/805,349, entitled “Electrical Power Apparatus with Retractable Cords and Moveable Sockets” which was filed on May 23, 2007 and issued as U.S. Pat. No. 7,510,426 on Mar. 31, 2009, and is related to U.S. Provisional Patent Application Ser. No. 60/808,448, entitled “Electrical Power Apparatus with Retractable Cords and Moveable Sockets” which was filed on May 26, 2006.

### BACKGROUND OF THE INVENTION:

1. FIELD OF THE INVENTION:

This invention relates to an electrical power apparatus and more particularly, a surge protector having retractable or extendable cords and rotatable or moveable sockets. More specifically, the present invention relates to an electrical power apparatus comprising: a housing comprising a top portion, a bottom portion and side walls, the housing having at least one indentation situated at the top portion and a slot situated on the side wall; and at least one socket component connected to a retractable cord, the socket component being situated within the indentation of the housing at a first position perpendicular to the bottom portion of the housing and moveable to the slot of the housing at a second position parallel to the bottom portion of the housing, and at a third position wherein the cord is extended and there is a distance between the socket component and the housing.

2. DESCRIPTION OF THE RELATED ART:

There are some surge protectors with retractable power cords in the prior art which utilizes a reel based mechanism. There are also wall mounted receptacles with retractable cords using cord reel assemblies. There are also surge protectors with a plurality of socket components attached to a plurality of cords which are connected to the housing of the surge protector.

Unlike the prior art, the present invention provides for an electrical power apparatus with moveable socket components capable of multiple angles in relation to the housing and further comprising socket components having retractable cords.

### SUMMARY OF THE INVENTION

In one embodiment, the present invention relates to an electrical power apparatus comprising: a housing comprising a top portion, a bottom portion and side walls, the housing having at least one indentation situated at the top portion and a slot situated on the side wall; and at least one socket component connected to a retractable cord, the socket component being situated within the slot of the housing at a first position perpendicular to the bottom portion of the housing and moveable to the indentation of the housing at a second position parallel to the bottom portion of the housing, and at a third position wherein the cord is extended and there is a distance between the socket component and the housing.

In another embodiment, the socket component comprises a head and a stem, and the stem is connected to the retractable cord. In yet another embodiment, the stem of the socket component is designed to sit within the slot allowing the head to be situated adjacent to the side wall of the housing. In still another embodiment, the top portion and bottom portion of the housing forms an internal cavity, and the indentation has an aperture, the cord is situated within the aperture and the internal cavity during a non-extended position.

In still yet another embodiment, the apparatus further comprises a surge protector and a power source, the surge protector is designed to protect electrical devices connected to the socket components from electrical surges from the power source.

In a further embodiment, the socket component comprises a means for retracting the cord. In yet a further embodiment, the apparatus further comprises an electrical power cord attached to the housing. In still a further embodiment, the electrical power cord is a retractable cord and comprises a means for retracting the electric power cord. In still yet a further embodiment, the apparatus further comprising a visual power signal source.

In another further embodiment, the present invention relates to an electrical power apparatus comprising: an elongated housing comprising a top portion, a bottom portion and at least one set of opposing side walls, the housing has at least one slot situated at the top portion and at least two indentations, each indentation being situated adjacent to the slot and situated on each of the opposing side wall; and at least one socket component connected to a retractable cord, the socket component being situated within the slot of the housing at a first position perpendicular to the bottom portion of the housing and moveable to the first indentation of the housing at a second position parallel to the bottom portion of the housing, the socket component is moveable to the second indentation at a third position parallel to the bottom portion of the housing and at a fourth position wherein the cord is extended and there is a distance between the socket component and the housing.

In yet another further embodiment, the present invention provides for electrical power apparatus comprising: an elongated housing comprising a top surface portion and at least one set of opposing side walls; and a plurality of socket components, each of the socket component being situated on the top surface portion of the housing at a first position and moveable to a second position parallel at one side of the opposing sidewalls of the housing, each of the socket components being moveable to a third position to a second side of the opposing sidewalls of the housing. In this embodiment, the socket component is moveable about 180 degrees.

In still another further embodiment, at least one of the socket components comprises a retractable cord. In still yet another further embodiment, at least one of the socket components is moveable to a fourth position wherein the cord is extended creating a distance between the socket component and the housing.

In another embodiment, the apparatus further comprises a surge protector, a power source and electrical power cord, and the surge protector designed to protect electrical devices connected to the socket components from electrical surges from the power source.

In a further embodiment, the present invention further provides an electrical power apparatus comprising: a housing comprising a top portion and at least one side wall; and at least one socket component connected to a retractable cord, the socket component being situated at a first position on the top portion of the housing and moveable to a second position on the side wall of the housing, and at a third position wherein the cord is extended creating a distance between the socket component and the housing.

In the above mentioned embodiment, the socket component is moveable about 90 degrees. In another embodiment, the user may pull on the socket component thereby extending the cord to a certain length and then locks into place; when the user is done using the socket component, the user then again pulls or tugs on the socket component and the cord will then retract back into the housing.

In a further embodiment, the retractable cord attached to the socket component can use any means for retraction including, but not limited to, cord reels, cord pins, mechanisms utilized in retractable cords for vacuum cleaners, etc.

In another further embodiment, the side walls comprises a securing means such as pins, clips, etc. for securing the retractable cord of the socket component when the socket component is in an extended position.

In a further embodiment, the apparatus comprises tracks on which the retractable cords sit and ride during extension and retraction. These tracks are situated within the housing of the apparatus.

In another embodiment, the present invention provides for an electrical power apparatus comprising: a housing comprising a top portion and at least one side wall; at least one surge protector situated within the housing; and at least one socket component connected to a retractable cord, the socket component is situated at a first position on the top portion of the housing and moveable to a second position on the side wall of the housing, and at a third position wherein the cord is extended creating a distance between the socket component and the housing, wherein the housing further comprises a bottom portion, a slot situated at the top portion and at least one indentation situated on the side wall, the socket component is situated within the slot of the housing and moveable to at least one indentation of the housing at the second position parallel to the bottom portion of the housing, and at the third position wherein the cord is extended and there is a distance between the socket component and the housing.

In another further embodiment, the present invention relates to an electrical power apparatus comprising: an elongated housing comprising a top portion, a bottom portion and at least one set of opposing side walls, said housing having at least one slot situated at said top portion and at least two indentations, each indentation being situated adjacent to said slot and situated on each of said opposing said side wall; and at least one socket component connected to a retractable cord, said socket component being situated within said slot of said housing at a first position perpendicular to said bottom portion of said housing and moveable to one of said two indentations of said housing at a second position parallel to said bottom portion of said housing, said socket component is moveable to other of said two indentations at a third position parallel to said bottom portion of said housing and at a fourth position wherein said cord is extended and there is a distance between said socket component and said housing.

In yet another further embodiment, the present invention provides for a electrical power apparatus is provided, the apparatus comprises: a housing comprising a top portion, a bottom portion and side walls creating an external surface generally perpendicular to said top and bottom portions and an internal cavity, said housing having at least one slot situated at the top portion and at least one indentation, the indentation is situated adjacent to the slot and situated on the side walls of the housing; and at least one socket component connected to an extendable cord, the socket component is situated within the indentation of the housing at a first position generally perpendicular to the top and bottom portions of the housing and moveable to the slot of the housing at a second position parallel to the top and bottom portions of the housing.

In still another further embodiment, the present invention relates to a electrical power apparatus comprising: a housing comprising a top portion, a bottom portion, side walls, a plurality of indentations situated on the side walls and a plurality of slots situated on said top portion, each slot is situated adjacent to each of said indentation; and a plurality of socket components connected to a retractable cord, each of the socket components is situated within each of the slots of the housing at a first position generally perpendicular to the top portion of the housing and moveable to one of the indentations at a second position parallel to the bottom portion of the housing, and at a third position wherein at least one of the cords is extended and there is a distance between the socket component and the housing.

In still yet another further embodiment, at least portions of the side walls form a generally round shape. In another embodiment, at least portions of the side walls form at least one corner. In still another embodiment, at least a portion of the top and bottom portions of the housing form a generally round shape. In yet another embodiment, at least a portion of the top and bottom portions of the housing form at least one corner. The housing may be round, square, rectangular, a pentagon, hexagon, octagon or any shape.

In a further embodiment, the present invention provides for a surge protector apparatus comprises: a housing comprising a top portion, a bottom portion and side walls creating an external surface generally perpendicular to the top and bottom portions and an internal cavity; at least one surge protector and at least one spool situated within the internal cavity of the housing; and at least one extendable and retractable cord having opposing ends, at least one socket component is directly attached to one end of the cord, and the opposing end of the cord is attached to a portion of the spool, and the cord has at least one flat side surface, and the flat surface of the cord contacting a portion of the spool during a retracted position.

In yet another further embodiment, the present invention relates to a electrical power apparatus comprising: a housing comprising a top portion, a bottom portion and side walls creating an external surface generally perpendicular to the top and bottom portions and an internal cavity, and the housing having at least one slot situated at the top portion and at least one indentation situated on the side walls, and the indentation is situated adjacent to said slot; and at least one socket component directly connected to an extendable and retractable cord, and the cord has two opposing sides, each of the sides of the cord having a flat surface, and the housing comprises at least one spool situated within the internal cavity, and the cord is designed to wrap around said spool during a retracted position.

In still another further embodiment, the flat surface of the cord contacts the spool during the retracted position.

In still yet another further embodiment, the present invention relates to a electrical power apparatus comprising: a housing comprising a top portion, a bottom portion, side walls, a plurality of indentations situated at the side walls and a plurality of slots situated on the top portion, each of the slots is situated adjacent to each of the indentation; a plurality of socket components; and at least one of the socket components is directly connected to an extendable and retractable cord, and the cord has at least one flat side, the socket components with the cord is situated within one of the slots at a first position wherein the socket component with the cord is generally perpendicular to the top portion of the housing and moveable to one of the indentations to a second position wherein the socket component with the cord is generally parallel to the top portion of the housing, and at a third position wherein at least a portion of the cord is extended out of the housing to allow a distance between the socket component and the housing.

In another embodiment, the cord has two opposing sides and the opposing sides comprise flat surface and when the cord is retracted, the cord wraps around the spool and at least a potion of the flat surface of the cord contacts a portion of the spool.

### BRIEF DESCRIPTION OF THE DRAWINGS

The accompanying drawings are included to provide a further understanding of the present invention. These drawings are incorporated in and constitute a part of this specification, illustrate one or more embodiments of the present invention, and together with the description, serve to explain the principles of the present invention.

FIG. 1 is an overhead view of one of the embodiments of the present invention;

FIG. 2 is a perspective view of one of the embodiments of the socket component of the present invention;

FIG. 3 is an overhead view of another embodiment of the present invention showing an elongated housing;

FIG. 4 is a perspective view of FIG. 1;

FIG. 5 is a cutaway side view of FIG. 1;

FIG. 6 is a perspective view of FIG. 3;

FIG. 7 is a cutaway side view of FIG. 3;

FIG. 8 is a perspective view of the flat surface of the cord and the socket component;

FIG. 9 is a perspective view of cord and the spool; and

FIG. 10 is a cutaway side view of the cord and spool in a retracted position.

Among those benefits and improvements that have been disclosed, other objects and advantages of this invention will become apparent from the following description taken in conjunction with the accompanying drawings. The drawings constitute a part of this specification and include exemplary embodiments of the present invention and illustrate various objects and features thereof.

### DETAILED DESCRIPTION OF THE INVENTION

As required, detailed embodiments of the present invention are disclosed herein; however, it is to be understood that the disclosed embodiments are merely exemplary of the invention that may be embodied in various forms. The figures are not necessary to scale, some features may be exaggerated to show details of particular components. Therefore, specific structural and functional details disclosed herein are not to be interpreted as limiting, but merely as a basis for the claims and as a representative basis for teaching one skilled in the art to variously employ the present invention.

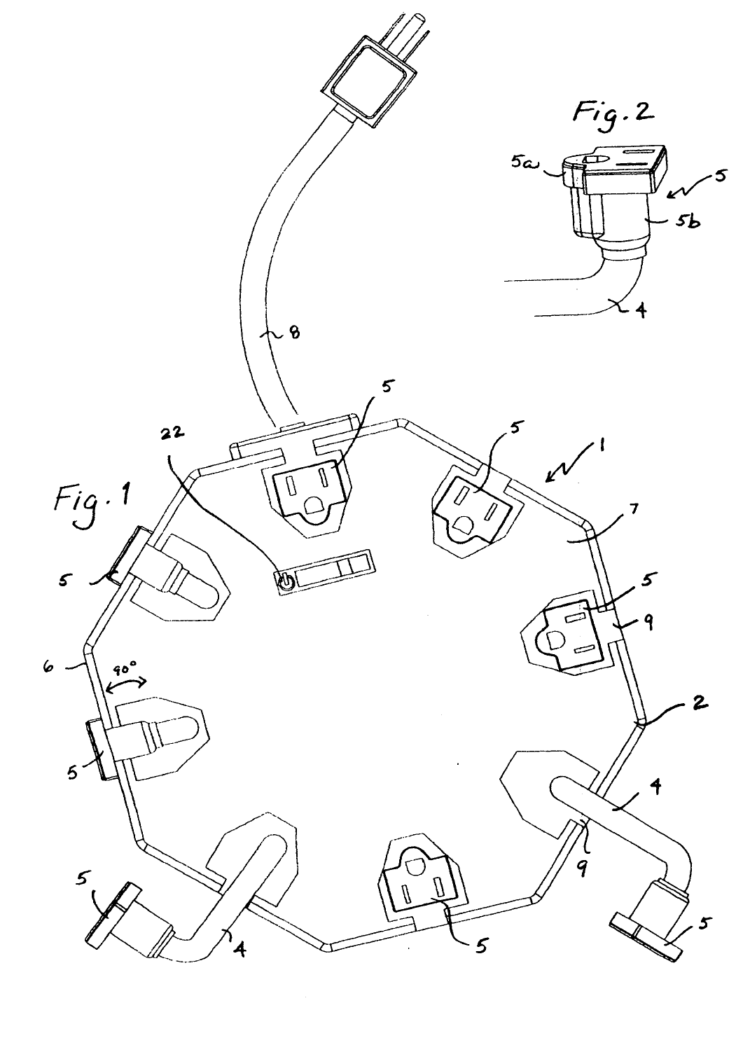

FIG. 1 illustrates an overhead view of one of the embodiments of the electrical power apparatus 1 of the present invention. The electrical power apparatus 1 comprises: a housing 2 comprising a top portion 7 and at least one side wall 6; and at least one socket component 5 connected to a retractable cord 4, the socket component 5 being situated at a first position on the top portion 7 of the housing 2 and moveable to a second position on the side wall 6 of the housing 2, and at a third position wherein the cord 4 is extended creating a distance between the socket component 5 and the housing 2.

The socket component 5 is moveable about 90 degrees. The user may pull on the socket component 5 thereby extending the cord 4 to a certain length and then locks into place; when the user is done using the socket component 5, the user then again pulls or tugs on the socket component Sand the cord 4 will then retract back into the housing 2.

FIG. 2 shows one embodiment of the socket component 5; the socket component 5 comprises a head 5a and a stem 5b, and the stem 5b is connected to the retractable cord 4.

FIG. 3 illustrates another embodiment of the electrical power apparatus 10 of the present invention using an elongated housing 12. The electrical power apparatus 10 comprises: an elongated housing 12 comprising a top surface portion 17 and at least one set of opposing side walls 16a and 16b respectively; and a plurality of socket components 15, each of the socket components 15 being situated at a first position on the top surface portion 17 of the housing 12 and moveable to a second position on one side 16a of the opposing sidewalls of the housing 12, each of the socket components 15 being moveable to a third position to a second side 16b of the opposing sidewalls of the housing 12. In this embodiment, the socket components 15 are moveable about 180 degrees.

FIG. 4 illustrates a perspective view of FIG. 1. The electrical power apparatus 1 comprises: a housing 2 comprising a top portion 7 and at least one side wall 6; and at least one socket component 5 connected to a retractable cord 4, the socket component 5 being situated at a first position on the top portion 7 of the housing 2 and moveable to a second position on the side wall 6 of the housing 2, and at a third position wherein the cord 4 is extended creating a distance between the socket component 5 and the housing 2. The cord 4 is retractable allowing for a first position wherein the socket component 5 and cord 4 are in a retracted position and a second position wherein the cord 4 is extended away from the housing allowing for an extended position. The visual power signal source 22 is situated on the top portion 7 of the housing 2. There are indentations 9 which allow the socket components to be in the second position on the side wall 6 of the housing 2. An electrical power cord 8 is also attached to the housing 2.

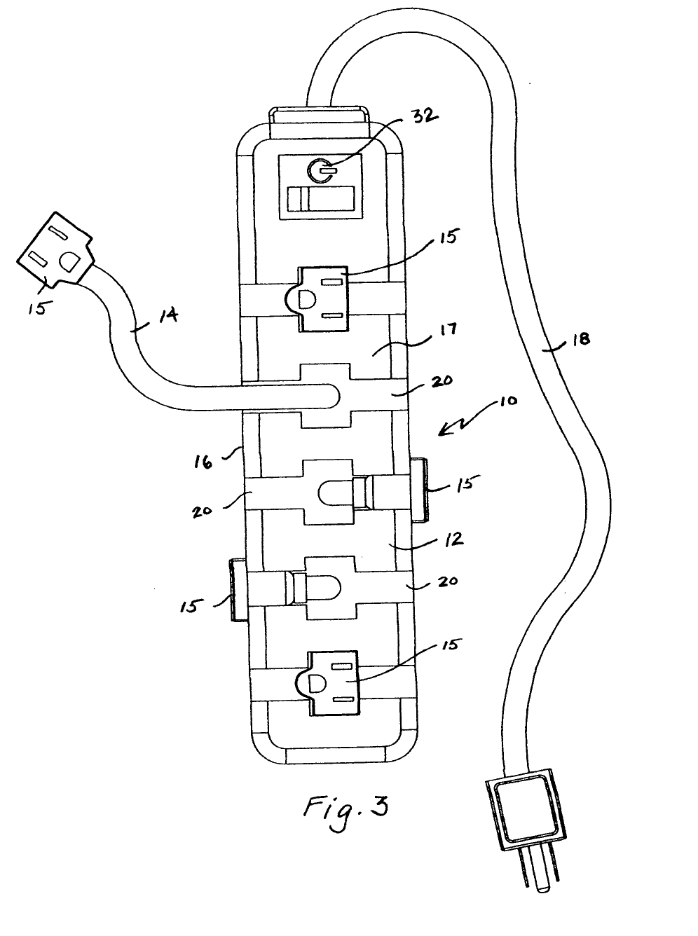

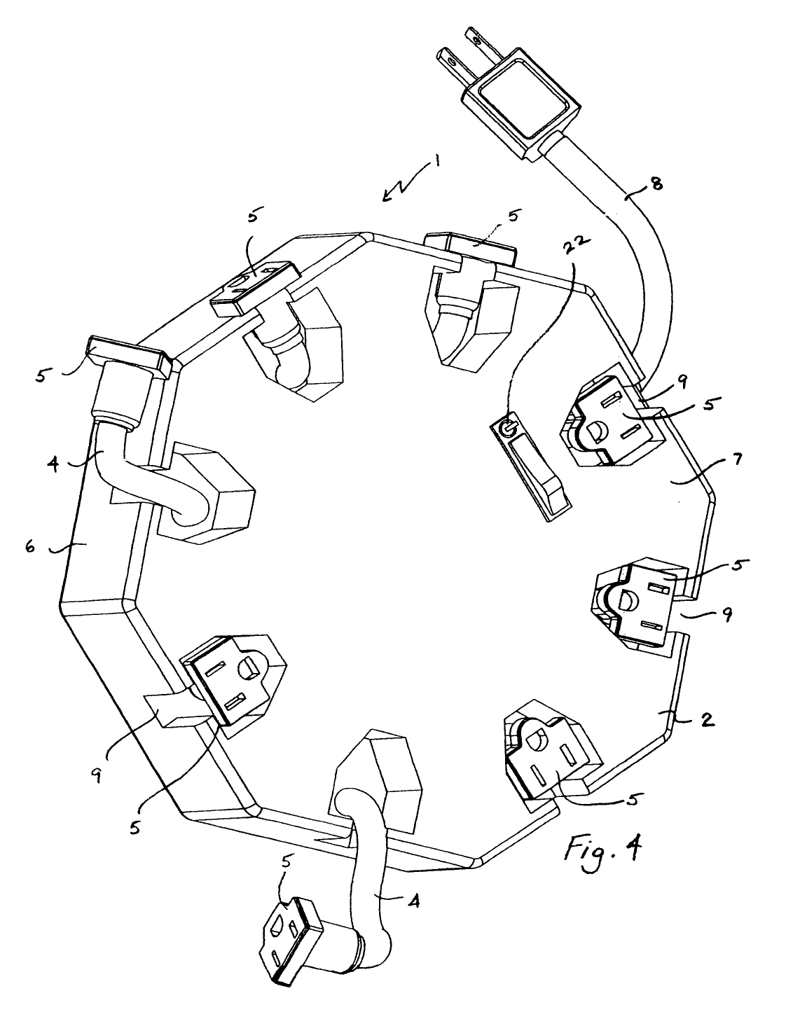

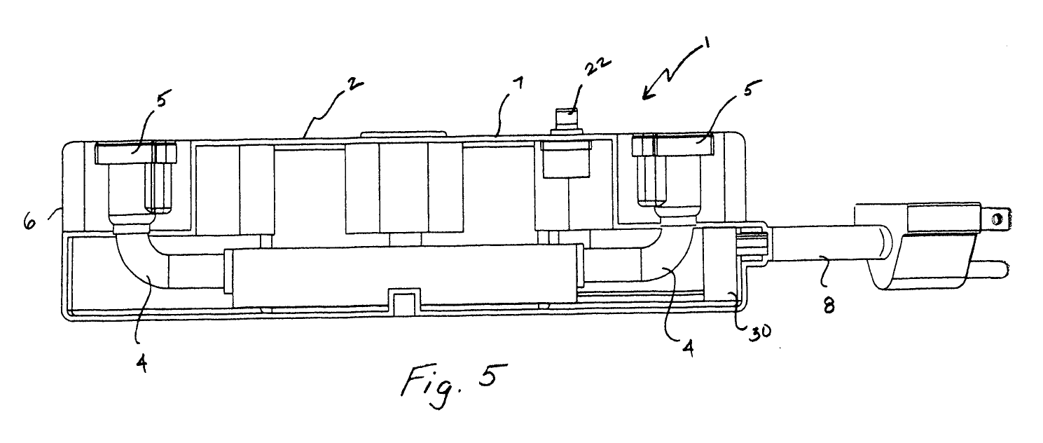

FIG. 5 illustrates a cutaway side view of FIG. 1. The electrical power apparatus 1 further comprises a surge protector 30 and a power source such as an electrical outlet. The visual power signal source 22 is situated on the top portion 7 of the housing 2 and an electrical power cord 8 is also attached to one of the side walls 6 the housing 2. FIG. 5 also shows the retractable electrical power cord 8.

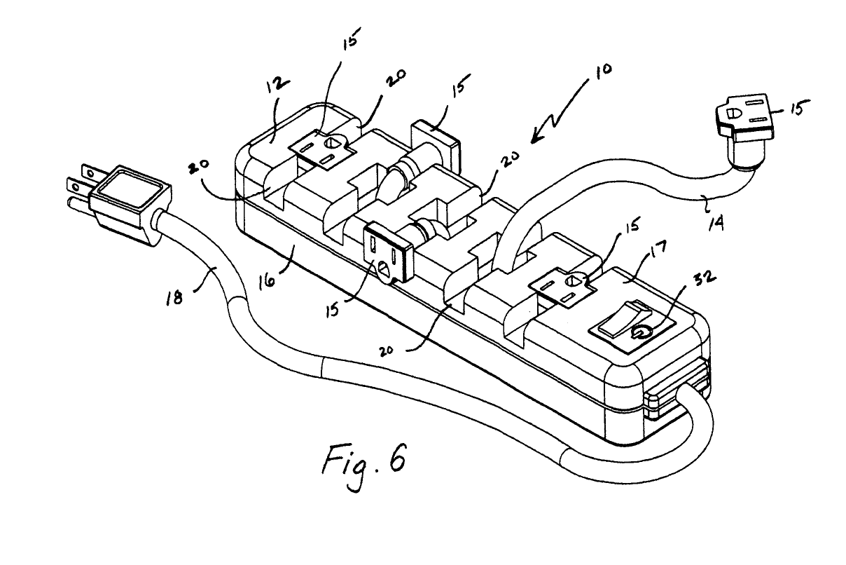

FIG. 6 illustrates a perspective view of FIG. 3. The electrical power apparatus 10 comprises: an elongated housing 12 comprising a top surface portion 17 and at least one set of opposing side walls 16a and 16b respectively; and a plurality of socket components 15, each of the socket components 15 being situated at a first position on the top surface portion 17 of the housing 12 and moveable to a second position on one side 16a of the opposing sidewalls of the housing 12, each of the socket components 15 being moveable to a third position to a second side 16b of the opposing sidewalls of the housing 12. In this embodiment, the socket components 15 are moveable about 180 degrees. At least one of the socket components 15 is attached to a cord 14. The cord 14 is retractable allowing for a first position wherein the socket component 15 and cord 14 are in a retracted position and a second position wherein the cord 14 is extended away from the housing allowing for an extended position. The visual power signal source 32 is situated on the top portion 17 of the housing 12. There are indentations 20 which allow the socket components 15 to be in the second position on the side wall 16 of the housing 12. An electrical power cord 18 is also attached to the housing 12.

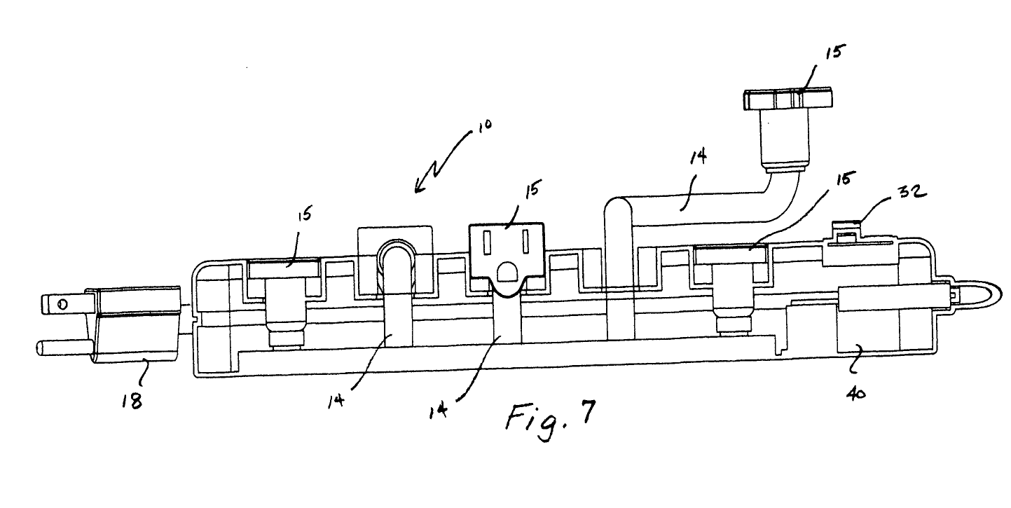

FIG. 7 illustrates a cutaway side view of FIG. 3. The electrical power apparatus 10 further comprises a surge protector 40 and a power source such as an electrical outlet. The visual power signal source 32 is situated on the top portion 17 of the housing 12 and an electrical power cord 18 is also attached to one of the side walls 16 the housing 12. FIG. 5 also shows the retractable electrical power cord 18.

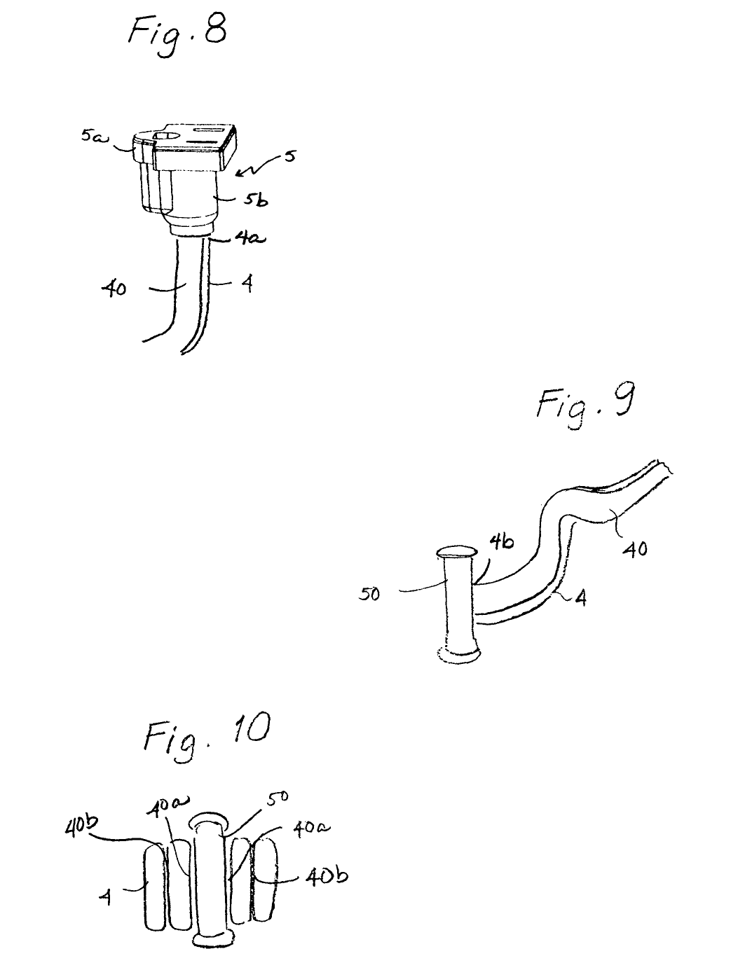

Referring now to FIGS. 8-10, the present invention shows the cord 4 with the flat side surface 40 and one end of the cord 4a is directly connected to the socket component 5 with the head 5a and stem 5b. The opposing end 4b of the cord 4 is directly connected to a portion of the spool 50. In one embodiment, the cord 4 has two opposing flat surface sides, 40a and b respectively, which contact one another and at least a portion of the spool 50 during the retracted position.

Numerous modifications and variations of the present invention are possible in light of the above teachings. It is therefore to be understood that within the scope of the attendant claims attached hereto, this invention may be practiced otherwise than as specifically disclosed herein.

What is claimed is:

1. An electrical power apparatus comprising:
a housing comprising a top portion, a bottom portion and side walls creating an external surface generally perpendicular to said top and bottom portions and an internal cavity, said housing having at least one slot situated at said top portion and at least one indentation situated on said side walls, said indentation being situated adjacent to said slot; and
at least one socket component directly connected to an extendable and retractable cord, said cord having two opposing sides, each of said sides of said cord having a flat surface, said housing comprising at least one spool situated within said internal cavity, said cord being designed to wrap around said spool during a retracted position.

2. The apparatus of claim 1 wherein said socket component being situated within said slot of said housing at a first position generally perpendicular to said bottom portion of said housing and moveable to said indentation of said housing at a second position generally parallel to bottom portion of said housing, and, at least a portion of said cord is extended out of said housing to allow a distance between said socket component and said housing.

3. The apparatus of claim 1 wherein said socket component comprises a head and a stem, said stem being connected to said cord, said stem of said socket component being designed to sit within said indentation allowing said head to be situated on said side walls of said housing.

4. The apparatus of claim 1 wherein said flat surface of said cord contacts said spool during said retracted position.

5. The apparatus of claim 1 further comprising a surge protector and a power source, said surge protector designed to protect electrical devices connected to said socket component from electrical surges from said power source, said surge protector being situated within said internal cavity of said housing.

6. The apparatus of claim 2 wherein said socket component comprises means for retracting said cord.

7. The apparatus of claim 1 further comprising an electrical power cord attached to said housing.

8. The apparatus of claim 7 wherein said electrical power cord is a retractable cord and comprises means for retracting said electric power cord.

9. The apparatus of claim 1 further comprising a visual power signal source.

10. The apparatus of claim 1 wherein at least portions of said side walls form a generally round shape.

11. The apparatus of claim 1 wherein at least portions of said side walls form at least one corner.

12. The apparatus of claim 1 wherein said indentation is situated on said external surface of said side walls.

13. An electrical power apparatus comprising:
a housing comprising a top portion, a bottom portion, side walls, a plurality of indentations situated at said side walls and a plurality of slots situated on said top portion, each of said slots being situated adjacent to each of said indentation;
a plurality of socket components; and
at least one of said socket components being directly connected to an extendable and retractable cord, said cord having at least one flat side, said socket components with said cord being situated within one of said slots at a first position wherein said socket component with said cord is generally perpendicular to said top portion of said housing and moveable to one of said indentations to a second position wherein said socket component with said cord is generally parallel to said top portion of said housing, and at a third position wherein at least a portion of said cord is extended out of said housing to allow a distance between said socket component and said housing.

14. The apparatus of claim 13 wherein said socket component comprises a head and a stem, said stem being connected to said cord.

15. The apparatus of claim 14 wherein said stem of said socket component being designed to sit within one of said indentations allowing said head to be situated adjacent to said side wall of said housing.

16. The apparatus of claim 13 wherein said housing comprises a spool, said cord being designed to wrap around said spool during a retracted position, said flat surface of said cord being designed to contact said spool and at least a portion of flat surface during said retracted position.

17. The apparatus of claim 13 further comprising a surge protector, a power source and electrical power cord, said surge protector designed to protect electrical devices connected to said socket components from electrical surges from said power source.

18. The apparatus of claim 17 wherein electrical power cord is a retractable cord and comprises means for retracting said electric power cord.

19. The apparatus of claim 13 wherein at least a portion of said top and bottom portions of said housing form a generally round shape.

20. A surge protector apparatus comprising:
a housing comprising a top portion, a bottom portion and side walls creating an external surface generally perpendicular to said top and bottom portions and an internal cavity;
at least one surge protector and at least one spool situated within said internal cavity of said housing; and
at least one extendable and retractable cord having opposing ends, at least one socket component being directly attached to one end of said cord, said opposing end of said cord being attached to a portion of said spool, said cord having at least one flat side surface, said flat surface of said cord contacting a portion of said spool during a retracted position.
